(19) United States
(12) Patent Application Publication
(10) Pub. No.: US 2008/0071041 A1
(43) Pub. Date: Mar. 20, 2008

(54) Sturdy, non-foamed, transparent, elastomeric moldings

(76) Inventors: Eva Emmrich, Essen (DE); Klaus Brecht, Burscheid (DE); Uwe Pfeuffer, Leverkusen (DE)

Correspondence Address: BAYER MATERIAL SCIENCE LLC, 100 BAYER ROAD, PITTSBURGH, PA, 15205, US

(21) Appl. No.: 11/895,924

(22) Filed: Aug. 28, 2007

(30) Foreign Application Priority Data
Aug. 30, 2006 (DE) 102006040566.8

(51) Int. Cl. C08G 18/28

(52) U.S. Cl. 525/460

(57) ABSTRACT

The invention relates to sturdy, transparent, elastomeric polyurethane moldings, to a process for production thereof, and also the use of these moldings.

### CROSS REFERENCE TO RELATED PATENT APPLICATION

The present patent application claims the right of priority under 35 U.S.C. § 119 (a)-(d) of German Patent Application No. 10 2006 040 566.8, filed Aug. 30, 2006.

### BACKGROUND OF THE INVENTION

The present invention relates to sturdy, transparent, elastomeric polyurethane moldings, a process for production thereof, and the use thereof.

Sturdy, transparent polyurethane (PUR) elastomers have been known for a long time, and suitable for use in a wide variety of end-use applications. Polyurethane gels as described in DE-A 100 24 097 are particularly worth mentioning here.

In general, polyurethane gels are transparent materials with a high specific weight. They are distinguished by certain mechanical properties, such as, for example, good shock-absorption. This viscoelastic behavior is particularly well pronounced in relatively thin layers. As an example here, the use of PUR gels in heel cushion pads may be mentioned. However, if the layer thickness is too great, it is observed that the energy-absorption of the material becomes very high. However, a lower damping, especially in this end-use application, is more favorable for physiological considerations and reasons. [See Dissertation Walter M., Zusammenhänge zwischen der subjektiven Beurteilung von Laufschuhen, den Materialdaten, sowie kinetischen und kinematischen Parametern des Gangzyklus, Universität Würzburg, 2001].

Another disadvantage of these dimensionally stable gels lies in their production. In this connection, a long-chain polyol is reacted with a polyisocyanate at a low index. By virtue of this so-called undercuring, the required processing times are frequently too long. Furthermore, the molding has a tacky surface. A tack-free surface can be generated in an additional working step by encasing the gels with coatings of different kinds. A further disadvantage is the deficient adhesion between the gel and the covering layer which, for example, may consist of leather or other textiles (such as, for example, in the case where gels are being used for midsoles).

Despite the disadvantages, PUR gels are frequently used in moldings due to their appealing transparent optical properties.

The object of the present invention was to provide polyurethane moldings that do not exhibit the disadvantages of the PUR gels which have been described (e.g. long demolding-times, tacky surfaces and high damping), but which at the same time also possess an optically interesting and appealing, attractive external appearance, and which exhibit a selectively adjustable elasticity.

Surprising, the present object was achieved by means of the sturdy, transparent, elastomeric polyurethane moldings according to the invention.

### SUMMARY OF THE INVENTION

The present invention provides sturdy, unfilled, transparent moldings which comprise a polyurethane elastomer, in which the molded part exhibits bubble-free, transparent, optical properties, and has a tack-free surface. These polyurethane elastomers comprise the reaction product of:

(A) a polyol formulation comprising of:

a) a polyol component comprising:
a1) at least one polyether polyol having an OH number of from 20 to 112, a functionality of 2, containing ≧45% by weight of primary OH groups, and which is the alkoxylation product of a suitable initiator with propylene oxide and/or ethylene oxide;
and
a2) at least one polyether polyol having an OH number of from 20 to 112, a functionality from greater than 2 to 6, containing containing ≧45% by weight of primary OH groups, and which is the alkoxylation product of a suitable initiator with propylene oxide and/or ethylene oxide;

b) one or more chain-extenders and/or crosslinking agents which has an OH number of from 600 to 2000;

c) one or more catalysts;

and, optionally,

d) one or more additives;

with

(B) an isocyanate component;

wherein the equivalent ratio of the NCO groups of (B) the isocyanate component to the sum of the hydrogen atoms of components a), b) and c) which are reactive in relation to isocyanate groups, ranges from 0.8:1 to 1.2:1, preferably from 0.95:1 to 1.15:1, and more preferably from 0.98:1 to 1.05:1.

The present invention also provides a process for producing sturdy, unfilled, transparent moldings which comprise polyurethane elastomers. These molded parts of polyurethane elastomer exhibit bubble-free, transparent optical properties, and have a tack-free surface.

This process comprises reacting or mixing:

(A) a polyol formulation comprising:

a) a polyol component comprising:
a1) at least one polyether polyol having an OH number of from 20 to 112, a functionality of 2, containing ≧45% by weight of primary OH groups, and which is the alkoxylation product of a suitable initiator with propylene oxide and/or ethylene oxide;
and
a2) at least one polyether polyol having an OH number of from 20 to 112, a functionality from greater than 2 to 6, containing containing ≧45% by weight of primary OH groups, and which is the alkoxylation product of a suitable initiator with propylene oxide and/or ethylene oxide;

b) one or more chain-extenders and/or crosslinking agents which has an OH number of from 600 to 2000;

c) one or more catalysts;

and, optionally,

d) one or more additives;

with

(B) an isocyanate component;

placing the mixture into a mold, and curing the mixture for no more than 5 minutes.

As discussed above, the equivalent ratio of the NCO groups of (B) the isocyanate component to the sum of the hydrogen atoms of components a), b) and c) that are reactive in relation to isocyanate groups ranges from 0.8:1 to 1.2:1, preferably 0.95:1 to 1.15:1, and more preferably 0.98:1 to 1.05:1.

### DETAILED DESCRIPTION OF THE INVENTION

The diisocyanates suitable for use in the present invention as component (B) include those known diisocyanates from polyurethane (PUR) chemistry, and preferably aromatic diisocyanates. In a preferred embodiment, prepolymers of diisocyanates are used. In particular, the preferred prepolymers comprise the reaction product of (1) 4,4′-diphenylmethane diisocyanate and/or modified 4,4′-diphenylmethane diisocyanate, with (2) a mixture comprising (a) one or more polyether polyols having an OH number of from 10 to 112, and (b) one or more polyethylene glycols and/or one or more polypropylene glycol having a molecular weight of from 135 to 700 g/mol. Suitable diisocyanates include, for example, those which have been modified such that they contain carbodiimide groups and/or allophanate groups.

Suitable compounds to be used as components a1), a2), b), c) and d) in the polyol formulation (A) are well-known. These are compounds which are all typically used in polyurethane chemistry.

The moldings of the invention preferably have a density ranging from 1050 kg/m³ to 1200 kg/m³.

These sturdy, elastomeric polyurethane moldings are suitable for use as, for example, various industrial articles and common consumer articles of daily use, and, in particular, as shoe soles and as shoe inserts.

The invention is explained in more detail in the following Examples.

The following examples further illustrate details for the process of this invention. The invention, which is set forth in the foregoing disclosure, is not to be limited either in spirit or scope by these examples. Those skilled in the art will readily understand that known variations of the conditions of the following procedures can be used. Unless otherwise noted, all temperatures are degrees Celsius and all percentages are percentages by weight.

### EXAMPLES

For the purpose of producing the moldings, the two components A (i.e. the polyol formulation) and B (i.e. the isocyanate component) were blended with one another by means of a screw (Klöckner Desma, Achim). The reaction mixture comprising the polyol formulation and the isocyanate was put into an open mold and cured.

Component A, having a material temperature of 30° C., was mixed with the NCO prepolymer component B, likewise with a material temperature of 30° C. The mixture was poured into an aluminium hinged mold (size 200 mm×70 mm×10 mm) which was maintained at a constant temperature of 50° C., and the hinged mold was closed. The molding was removed from the mold after a few minutes.

The Shore-A hardness according to DIN 53505, after storage for 24 h, was determined for the moldings produced in this way. Furthermore, the resilience according to DIN 53512 was ascertained. Moreover, indentation tests in accordance with DIN 53579, subsection IV, were carried out in respect of moldings.

The results of measurement are summarised in Table 1 below.

Starting Materials:

Polyether Polyols:

1) A mixture of tripropylene glycol and a polyether polyol based on propylene oxide, in which the mixture has a hydroxyl number of 163.
2) A polyether polyol having a hydroxyl number of 28, which contains 70% propylene-oxide units and 30% ethylene-oxide units with propylene glycol as the initiator, and contains 90% primary OH groups.
3) A polyether polyol having a hydroxyl number of 56, which contains 86% propylene-oxide units and 14% ethylene-oxide units with glycerine as the initiator, and contains about 45% primary OH groups.
4) A polyether polyol having a hydroxyl number of 28, which contains 82% propylene-oxide units and 18% ethylene-oxide units with sorbitol as the initiator, and contains 85% primary OH groups.
5) A polyether polyol having a hydroxyl number of 56, which contains 40% propylene-oxide units and 60% ethylene-oxide units with trimethylolpropane as the initiator, and contains >90% primary OH groups.
   Isocyanate Component:
1) A prepolymer having an NCO-content of 19.8%, prepared by reacting 66 parts by weight of 4,4′-diisocyanatodiphenylmethane (4,4′-MDI), 5 parts by weight modified 4,4′-MDI having an NCO-content of 30% (that is prepared by partial carbodiimidisation), and 29 parts by weight of polyether polyol 1).
2) A polymer-containing prepolymer having an NCO-content of 31.5% (commercially available as Desmodur 44V10L from Bayer MaterialScience AG).

### Example 1

### According to the Invention

The polyol formulation (A) comprised:

3712.50 parts by weight of the difunctional polyether polyol 2),

1125.00 parts by weight of polyether polyol 3),

75.00 parts by weight Dabco in ethylene glycol,

25.00 parts by weight diethylene glycol,

50.00 parts by weight triethanolamine,

12.50 parts by weight dimethyl-bis[(1-oxoneodecyl)oxy]stannane.

100 parts by weight of this polyol component were mixed with 24 parts by weight of prepolymer 1.

### Example 2

### According to the Invention

The polyol formulation (A) comprised:

3712.50 parts by weight of the difunctional polyether polyol 2),

1125.00 parts by weight of polyether polyol 4),

75.00 parts by weight Dabco in ethylene glycol,

25.00 parts by weight diethylene glycol,

50.00 parts by weight triethanolamine,

12.50 parts by weight dimethyl-bis[(1-oxoneodecyl)oxy]stannane.

100 parts by weight of this polyol component were mixed with 25 parts by weight of prepolymer 1.

### Example 3

### Comparison

The polyol formulation (A) comprised:

1000 parts by weight of the trifunctional polyether polyol 5),

10 parts by weight Dabco in dipropylene glycol.

100 parts by weight of this polyol component were mixed with 5 parts by weight of prepolymer 2.

### Example 4

### Comparison

A polyol formulation (A) (polyether polyol 2), polyetherpolyol 3), Dabco in ethylene glycol and dimethyl-bis-[(1-oxo-neodecyl)oxy]stannane) was mixed with prepolymer 1.

Without a chain extender/crosslinking agent almost no reaction took place; the mixture stayed liquid and did not become solid. The use of another, stronger catalyst (tin catalyst UL-32) was not successful, the mixture stayed liquid.

### Example 5

### Comparison

A polyol mixture (10 parts by weight of a polyetherpolyol {OH number 36, functionality F=3, TMP as a starter, 20% ethylene oxide, 80% propylene oxide}, 40 parts by weight of a polyetherpolyol {OH number 56, F=2, PG as a starter, 100% propylene oxide}, 50 parts by weight of a polyetherpolyol {OH number 56, F=3, TMP as a starter, 55% ethylene oxide, 45% propylene oxide}) and Coscat 83 (catalyst) were mixed with Desmodur® N3400 from Bayer MaterialScience AG.

There was almost no reaction so that the mixture stayed liquid.

TABLE 1

| | Example 1 | Example 2 | Example 3 |
|---|---|---|---|
| Hardness | 48/67 | 43/67 | 17/40 |
| [Shore A]/[Asker C] | | | |
| Resilience | 53 | 48 | 25 |
| [%] | | | |
| Rel. energy-absorption | 0.17 | 0.27 | 0.33 |
| ΔW* | | | |
| Minimum demolding- | 3.5 | 3 | 5.5 |
| time [min]** | | | |
| Optics/Surface | transparent | transparent | transparent |
| | dry | dry | tacky |
| Deformation [mm]*** | 0.65 | 0.82 | 3.11 |

*The energy-absorption ΔW is also called damping and was obtained by measuring the work done during loading of a sample in Newton and work during removal of the load from the sample, using the equation: ΔW = [W(loading) − W(removing load)]/W(loading)
**Minimum demolding-time is the time required to be able to remove the molded part from the mold, without deformation, and for the surface to be no longer tacky.
***Deformation in mm is determined by applying a constant force of 150 N to the sample.

As is evident from Table 1, Examples 1 and 2 according to the invention display
1.) a better demolding behavior (i.e. a shorter demolding-time),
2.) a transparent optical property with a dry, tack-free, bubble-free surface,
3.) a clearly lower deformation and, associated therewith, lower absorption of energy,
   and
4.) with almost constant degrees of hardness, selectively adjustable values of resilience.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A sturdy, unfilled, transparent molded part comprising a polyurethane elastomer, in which the molded part exhibits bubble-free, transparent optical properties and has a tack-free surface, wherein said polyurethane elastomer comprises the reaction product of
(A) a polyol formulation comprising:
a) a polyol component comprising:
a1) at least one polyether polyol having an OH value from 20 to 112, a functionality of 2, containing ≧45% by weight of primary OH groups, and which is the alkoxylation product of a suitable initiator with propylene oxide and/or ethylene oxide,
and
a2) at least one polyether polyol having an OH value from 20 to 112, a functionality of from greater than 2 to 6, containing ≧45% by weight of primary OH groups, and which is the alkoxylation product of a suitable initiator with propylene oxide and/or ethylene oxide;
b) one or more chain-extenders and/or crosslinking agents which has an OH number of from 600 to 2000;
c) one or more catalysts;
and, optionally,
d) one or more additives;
with
(B) an isocyanate component;
wherein the equivalent ratio of the NCO groups of the isocyanate component (B) to the sum of the hydrogen atoms of components a), b) and c) which are reactive in relation to isocyanate groups ranges from 0.8:1 to 1.2:1.

2. The sturdy, transparent molded parts of claim 1, in which a2) said polyether polyol has a functionality of from 3 to 6.

3. The sturdy, transparent molded parts of claim 1, in which the equivalent ratio of isocyanate (NCO) groups in (B) said isocyanate component, to the sum of hydrogen atoms which can react with isocyanate groups in components a), b) and c) ranges from 0.95:1 to 1.15:1.

4. The sturdy, transparent molded parts of claim 1, in which the equivalent ratio of isocyanate (NCO) groups in (B) said isocyanate component, to the sum of hydrogen atoms which can react with isocyanate groups in components a), b) and c) ranges from 0.98:1 to 1.05:1.

5. The molded part of claim 1, wherein (B) said isocyanate component comprises a prepolymer prepared by reacting (1) 4,4′-diphenyl-methane diisocyanate and/or modified 4,4′-diphenylmethane diisocyanate, with (2) a mixture comprising (a) one or more polyether polyols having an OH number of from 10 to 112, and (b) one or more polyethylene glycols and/or one or more polypropylene glycols having molecular weights of from 135 g/mol to 700 g/mol.

6. The molded part of claim 5, in which the modified 4,4′-diphenylmethane diisocyanate additionally contains carbodiimide groups and/or allophanate groups.

7. A process for producing sturdy, unfilled, transparent moldings which comprise polyurethane elastomers and exhibit bubble-free, transparent optical properties and have a tack-free surface, which comprises reacting
(A) a polyol formulation comprising:
a) a polyol component comprising:
a1) at least one polyether polyol having an OH value from 20 to 112, a functionality of 2, containing ≧45% by weight of primary OH groups, and which is the alkoxylation product of a suitable initiator with propylene oxide and/or ethylene oxide,
and
a2) at least one polyether polyol having an OH value from 20 to 112, a functionality of from greater than 2 to 6, containing ≧45% by weight of primary OH groups, and which is the alkoxylation product of a suitable initiator with propylene oxide and/or ethylene oxide;
b) one or more chain-extenders and/or crosslinking agents which has an OH number of from 600 to 2000;
c) one or more catalysts;
and, optionally,
d) one or more additives;
with
(B) an isocyanate component;
wherein the equivalent ratio of the NCO groups of the isocyanate component (B) to the sum of the hydrogen atoms of components a), b) and c) which are reactive in relation to isocyanate groups ranges from 0.8:1 to 1.2:1;
placing the reaction mixture of components (A) and (B) in a mold, and curing the reaction mixture for no more than 5 minutes.

8. The process of claim 7, in which a2) said polyether polyol has a functionality of from 3 to 6.

9. The process of claim 7, in which the equivalent ratio of isocyanate (NCO) groups in (B) said isocyanate component, to the sum of hydrogen atoms which can react with isocyanate groups in components a), b) and c) ranges from 0.95:1 to 1.15:1.

10. The process of claim 7, in which the equivalent ratio of isocyanate (NCO) groups in (B) said isocyanate component, to the sum of hydrogen atoms which can react with isocyanate groups in components a), b) and c) ranges from 0.98:1 to 1.05:1.

11. The process of claim 7, wherein (B) said isocyanate component comprises a prepolymer prepared by reacting (1) 4,4′-diphenyl-methane diisocyanate and/or modified 4,4′-diphenylmethane diisocyanate, with (2) a mixture comprising (a) one or more polyether polyols having an OH number of from 10 to 1112, and (b) one or more polyethylene glycols and/or one or more polypropylene glycols having molecular weights of from 135 g/mol to 700 g/mol.

12. The process of claim 11, in which the modified 4,4′-diphenylmethane diisocyanate additionally contains carbodiimide groups and/or allophanate groups.

13. Polyurethane articles, including shoe soles and shoe inserts, comprising the sturdy, transparent, unfilled moldings of claim 1.
